(19) United States
(12) Patent Application Publication
(10) Pub. No.: US 2009/0266963 A1
(43) Pub. Date: Oct. 29, 2009

(54) Clamp, system and/or method for securing an article to a fixture

(76) Inventors: Christopher Marszalek, Plainfield, IL (US); Jim Groth, Poplar Grove, IL (US); Daniel Horvath, Marseilles, IL (US)

Correspondence Address: PATENTS+TMS, P.C., 2849 W. ARMITAGE AVE., CHICAGO, IL, 60647, US

(21) Appl. No.: 12/148,882

(22) Filed: Apr. 23, 2008

(51) Int. Cl. F16M 13/02

(52) U.S. Cl. 248/316.1

(57) ABSTRACT

A clamp, a system and/or a method secures an article to a fixture. The clamp, the system and/or the method may prevent a theft and/or a removal of the article from the fixture. The clamp is attached to the article, such as, for example, a laptop computer. A vertical member extends from the clamp and may be situated within a recess of the article to prevent the clamp from being removed from the article. A tether secures the clamp and/or the article to the fixture. The vertical member of the clamp may have a plunger that may be depressed by the article while the article is situated within the clamp.

### BACKGROUND OF THE INVENTION

The present invention generally relates to a clamp, a system and/or a method for securing an article to a fixture. More specifically, the present invention relates to a clamp, a system and/or a method that may prevent a theft and/or a removal of the article from a fixture. The clamp may be attached to the article, such as, for example, a laptop computer. The article may be on display and/or may be used, manipulated, tested and/or transported by consumers in an environment, such as, for example, a retail store. A tether may secure the clamp and/or the article to the fixture. Moreover, the clamp may have a plunger alarm that may enter an alarm mode after the article is removed from the clamp.

It is generally known that retailers of articles provide one or more of the articles as samples that allow consumers to interact with the articles. The samples may be located on or near a display for the article wherein pricing information and/or product availability may be displayed. Further, power connections may be provided at the display to power the samples and/or security systems associated with the samples. Data connections may be provided at the display to provide internet access and/or other like network connectivity to the samples. Moreover, security tethers may be provided at the display to mechanically anchor the samples to the display. Samples are secured to prevent removal, theft and/or damage. Nonetheless, the presence of samples may be essential to marketing and/or sales of the article. Therefore, retailers must maintain an availability of the samples and/or control of a location of the samples to allow consumers to have exposure to the articles.

As a result, known security systems are provided and/or are used by retailers to secure a sample to its display and/or to alert security personnel of theft, destruction and/or tampering of the sample. The known security systems typically mechanically connect the samples to the display with a cable. A first end of the cable typically has a plate or a fitting that may be attached to the sample with an adhesive. Alternatively, the plate and/or the fitting may be specifically constructed, configured and/or sized for attachment to the sample with fasteners, such as, for example, screws, bolts or the like. In some cases, samples are constructed with tapped holes or other members specifically formed on and/or within the sample for receiving security systems. A second end of the cable may be attached to the display to prevent physical removal of the sample from the display.

The known security systems are typically electronically connected by means of wires to sensors attached to the samples. The wires are used to power the samples and/or to communicate with a control box at or near the display. The sensors of the known security systems typically detect tampering with the sample and/or removal of the sensor from the sample. As a result of theft or destruction and/or tampering of the article, the control box of the known security system often sounds an alarm at or near the display stand where the control box may be located. Known security systems, however, are often difficult to install, may be large and/or bulky and/or may be expensive to produce and/or maintain. Further, known security systems are often difficult to remove even by staff of the retailers. Moreover, known security systems may only be suitable for attachment to a single type and/or model of the sample and may not be suitable for attachment to a variety of types and/or models of samples on display in a retail store. Therefore, a variety of systems may be required to secure a variety of samples in a retail store environment. Moreover, extensive fabrication may be required to adapt known security systems for attachment to the specific samples on display in the retail store environment.

A need, therefore, exists for a clamp, a system and/or a method for securing an article to a fixture. Additionally, a need exists for a clamp, a system and/or a method that may prevent a theft and/or a removal of the article from the fixture. Further, a need exists for a clamp, a system and/or a method that may be used to secure any articles having one or more recesses on a generally flat surface of the article. Still further, a need exists for a clamp, a system and/or a method that may be adjusted to accommodate various widths of various articles. Still further, a need exists for a clamp, a system and/or a method that may have a vertical member for insertion into one or more recesses on a surface of the article. Still further, a need exists for a clamp, a system and/or a method that may be easily and/or quickly attached and/or removed from the article by an authorized individual. Still further, a need exists for a clamp, a system and/or a method that may have an alarm within the vertical member to detect a removal of the article from the clamp. Moreover, a need exists for a clamp, a system and/or a method that may eliminate a need to manufacture the article specifically for security to a display in a retail store.

### SUMMARY OF THE INVENTION

The present invention generally relates to a clamp, a system and/or a method for securing an article to a fixture. More specifically, the present invention relates to a clamp, a system and/or a method that may prevent a theft and/or a removal of the article from a fixture.

The clamp may be attached to the article, such as, for example, a laptop computer, a PDA, a television, a tablet computer, an external hard drive, a computer peripheral or other device that may be on display and/or may be used, manipulated, tested and/or transported by consumers in an environment, such as, for example, a retail store. The article may have a width defined between a first surface and a second surface that may be located in a position generally parallel to the first surface. The clamp may be adjusted according to the width of the article.

The article may have one or more recesses, such as, for example, slots, screw holes, notches and/or the like that may be situated on the first surface and/or the second surface. The clamp may have a vertical member that may be inserted into one of the recesses as the clamp is secured to the first surface and the second surface of the article. The clamp, the system and/or the method may have a tether that may secure the clamp and/or the article to the fixture.

A plunger may be connected to a plunger circuit and may detect a secure attachment of the clamp to the article. The plunger circuit may be electrically connected to the a security system at the fixture to alert security personnel if the article is removed from the clamp. The security system may enter an alarm mode after the article is removed from the clamp.

To this end, in an embodiment of the present invention, a clamp for securing an article to a fixture is provided. The clamp has a first arm having a length defined between a first end and a second end wherein the second end of the first arm is positioned opposite to the first end of the first arm wherein the first arm has a height defined between a top surface and a bottom surface wherein the bottom surface of the first arm is positioned generally parallel to the top surface of the first arm. Further, the clamp has a second arm positioned generally parallel to the first arm. Still further, the clamp has a pin extending from the first end of the first arm towards the second arm in a direction perpendicular to the bottom surface of the first arm. Still further, the clamp has a shaft extending from the second arm towards the first arm in a direction perpendicular to the second arm wherein the shaft has an opening sized to receive the pin of the first arm. Moreover, the clamp has a member extending from the second arm in a direction perpendicular to the second arm to a point between the bottom surface of the first arm and the second arm wherein the member is generally cylindrical about an axis extending perpendicular to the second arm.

In an embodiment, the clamp has a threaded hole in the pin.

In an embodiment, the clamp has a fastener to connect the pin to the shaft.

In an embodiment, the clamp has an opening in the member between the second arm and the point.

In an embodiment, the clamp has a plunger extending from the member towards the bottom surface of the first arm wherein the plunger moves within the member.

In an embodiment, the clamp has an opening in the second arm that extends through the second arm.

In an embodiment, the clamp has a first plate attached to the second arm wherein the first plate has a width defined between a first side and a second side wherein the first side of the first plate is attached to the second arm to form a compartment between the second arm and the first plate.

In an embodiment, the clamp has a second plate attached to the second side of the first plate wherein the second plate the first plate to the second arm.

In an embodiment, the clamp has a coating on the first arm wherein the coating increases a friction force of the first arm.

In an embodiment, the clamp has a cable attached to the second arm and to the fixture.

In another embodiment, a system for securing an article to a fixture is provided. The system has a clamp having a first arm and a second arm wherein the first arm is positioned generally parallel to the second arm wherein the first arm is attached to the second arm. Further, the system has a member extending from the second arm towards the first arm in a direction perpendicular to the second arm to a point between the first arm and the second arm wherein the member is generally cylindrical about an axis that extends perpendicular to the second arm. Still further, the system has a plunger that extends from the first member towards the first arm wherein the plunger moves within the member in a direction perpendicular to the first arm and the second arm. Still further, the system has a plunger circuit in communication with the plunger wherein the plunger circuit is located within the second arm wherein the plunger circuit detects a movement of the plunger. Still further, the system has a first cable having a first end and second end wherein the first end is connected to the second arm. Moreover, the system has a second cable connected to the plunger circuit.

In an embodiment, the system has a mounting plate attached to the fixture wherein the second end of the first cable is attached to the mounting plate.

In an embodiment, the system has a collar attached to the article wherein the collar is generally cylindrical in shape wherein the collar has an opening sized to receive the member.

In an embodiment, the system has a fastener to attach the first arm of the clamp to the second arm of the clamp.

In an embodiment, the system has a light emitting diode electrically connected to the plunger circuit.

In an embodiment, the system has a coating on the first arm of the clamp wherein the coating protects the article from the first arm.

In another embodiment, a method for securing an article to a fixture wherein the article has a recess on a surface of the article is provided. The method has the step of providing a clamp having a first arm and a second arm wherein the second arm is positioned generally parallel to the first arm at a substantially continuous distance from the first arm wherein the clamp has a member that extends from the second arm towards the first arm wherein the clamp has a cable wherein the cable is attached to the second arm of the clamp and further wherein the clamp has a plunger circuit to detect an attachment of the clamp to the article. Further, the method has the step of positioning the article between the first arm and the second arm. Still further, the method has the step of inserting the member of the clamp into the recess of the article. Moreover, the method has the step of fastening the first arm to the second arm.

In an embodiment, the method has the step of activating the plunger circuit to detect a removal of the article from the clamp.

In an embodiment, the method has the step of adjusting the distance between the first arm and the second arm.

In an embodiment, the method has the step of attaching the cable to the fixture.

It is, therefore, an advantage of the present invention to provide a clamp, a system and/or a method for securing an article to a fixture.

Another advantage of the present invention is to provide a clamp, a system and/or a method for securing an article to a fixture that may prevent a theft and/or a removal of the article from a fixture.

And, another advantage of the present invention is to provide a clamp, a system and/or a method for securing an article to a fixture that may have a first arm and a second arm secured to the first arm in a position that may be parallel to the first arm.

Yet another advantage of the present invention is to provide a clamp, a system and/or a method for securing an article to a fixture wherein the article is, for example, a laptop computer, a PDA, a television, a tablet computer, an external hard drive, a computer peripheral or other device that may be on display and/or may be used, manipulated, tested and/or transported by consumers in an environment, such as, for example, a retail store.

A further advantage of the present invention is to provide a clamp, a system and/or a method for securing an article to a fixture that may secure the article between the first arm and the second arm.

Moreover, an advantage of the present invention is to provide a clamp, a system and/or a method for securing an article to a fixture wherein a distance between the first arm and the second arm may be adjusted according to a width of the article.

And, another advantage of the present invention is to provide a clamp, a system and/or a method for securing an article to a fixture wherein the second arm of the clamp may have a vertical member that may extend outward with respect to the second arm towards the first arm.

Yet another advantage of the present invention is to provide a clamp, a system and/or a method for securing an article to a fixture that may have a vertical member that may be positioned within a recess of the article, such as, for example, a notch, a screw hole, a slot and/or the like to prevent a removal of the article from the clamp.

Another advantage of the present invention is to provide a clamp, a system and/or a method for securing an article to a fixture that may have a tether to secure the clamp and/or the article to the fixture.

Yet another advantage of the present invention is to provide a clamp, a system and/or a method for securing an article to a fixture that may have a plunger alarm that may enter an alarm mode after the article is removed from the clamp.

A still further advantage of the present invention is to provide a clamp, a system and/or a method for securing an article to a fixture that may be easily and/or quickly attached and/or removed from the article by retail staff.

Moreover, an advantage of the present invention is to provide a clamp, a system and/or a method for securing an article to a fixture that may have a plunger alarm within the vertical member to detect a removal of the article from the clamp.

And, another advantage of the present invention is to provide a clamp, a system and/or a method for securing an article to a fixture that may eliminate a need to manufacture the article specifically for security to a display in a retail store.

Yet another advantage of the present invention is to provide a clamp, a system and/or a method for securing an article to a fixture that may have a fastener, such as, for example, a screw, a bolt or the like to tighten the clamp onto the article.

Moreover, an advantage of the present invention is to provide a clamp, a system and/or a method for securing an article to a fixture that may be slidably adjusted to fit a variety of articles.

And, another advantage of the present invention is to provide a clamp, a system and/or a method for securing an article to a fixture that may have a rubber coating on one or more arms of the clamp that may prevent a slippage of the article with respect to the clamp and/or that may reduce cosmetic damage to the article.

Yet another advantage of the present invention is to provide a clamp, a system and/or a method for securing an article to a fixture that may have a collar that may be attached to the article to create a recess for receiving the vertical member of the clamp.

Additional features and advantages of the present invention are described in, and will be apparent from, the detailed description of the presently preferred embodiments and from the drawings.

### BRIEF DESCRIPTION OF THE DRAWINGS

FIG. 1 illustrates a side view of a clamp and a system for securing an article to a fixture in an embodiment of the present invention.

FIG. 2 illustrates a side view of a clamp and a system for securing an article to a fixture in an embodiment of the present invention.

FIG. 3 illustrates a top plan view of a clamp and a system for securing an article to a fixture in an embodiment of the present invention.

FIG. 4 illustrates an exploded perspective view of a clamp and a system for securing an article to a fixture in an embodiment of the present invention.

FIG. 5 illustrates a side view of a clamp and a system for securing an article to a fixture in an embodiment of the present invention.

### DETAILED DESCRIPTION OF THE PRESENTLY PREFERRED EMBODIMENTS

The present invention generally relates to a clamp, a system and/or a method for securing an article to a fixture. More specifically, the present invention relates to a clamp, a system and/or a method that may prevent a theft and/or a removal of the article from a fixture. The article may have one or more recesses, such as, for example, slots, screw holes, notches and/or the like that may be used to secure the clamp to the article.

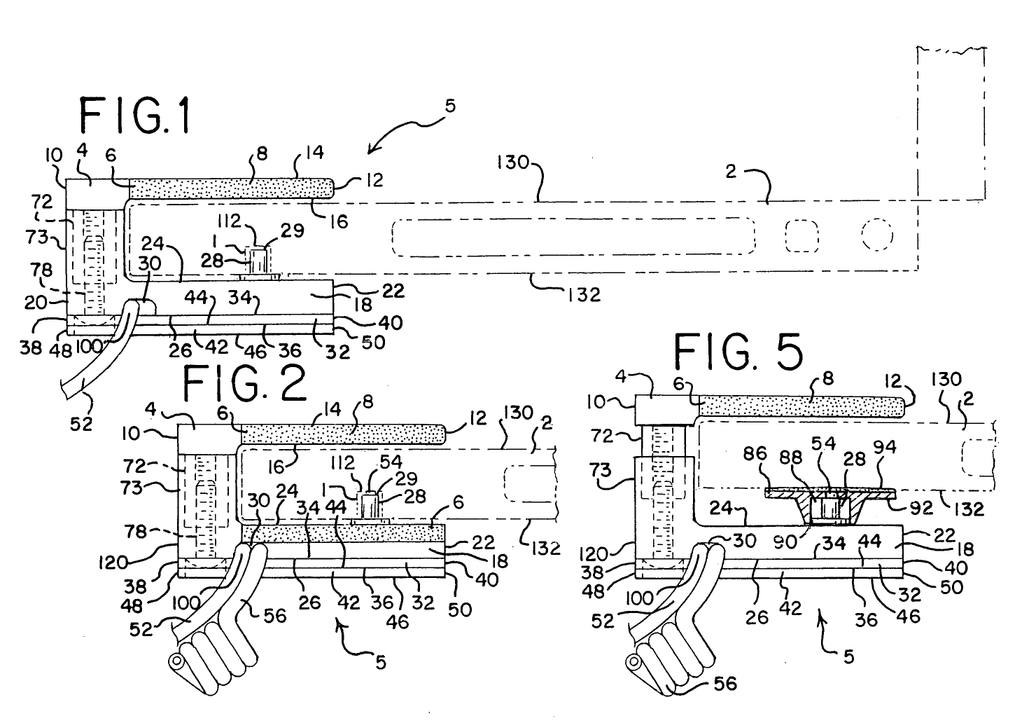

Referring now to the drawings wherein like numerals refer to like parts, FIGS. 1-5 illustrate a clamp 4, a system 5 and/or components of the clamp 4 and/or of the system 5 for securing an article 2 to a fixture (not shown) in embodiments of the present invention. In an embodiment, the article 2 may be a portable electronic device, such as, for example, a laptop computer, a tablet computer, a portable hard drive, a peripheral computer device, a printer, a television, a computer monitor, a cellular telephone, an mp3 player, a camera, a camcorder, a personal digital assistant (PDA), a gaming device, a handheld global positioning system (GPS), a laptop computer, a satellite radio, a remote control and/or the like. The article 2 may be on display and/or may be used, manipulated, tested and/or transported by consumers in an environment, such as, for example, a retail store. The present invention should not be deemed as limited to a specific embodiment of the article 2. It should be understood that the article 2 may be any article that may be sold and/or displayed in an environment offering any article, product and/or other merchandise as known to one having ordinary skill in the art.

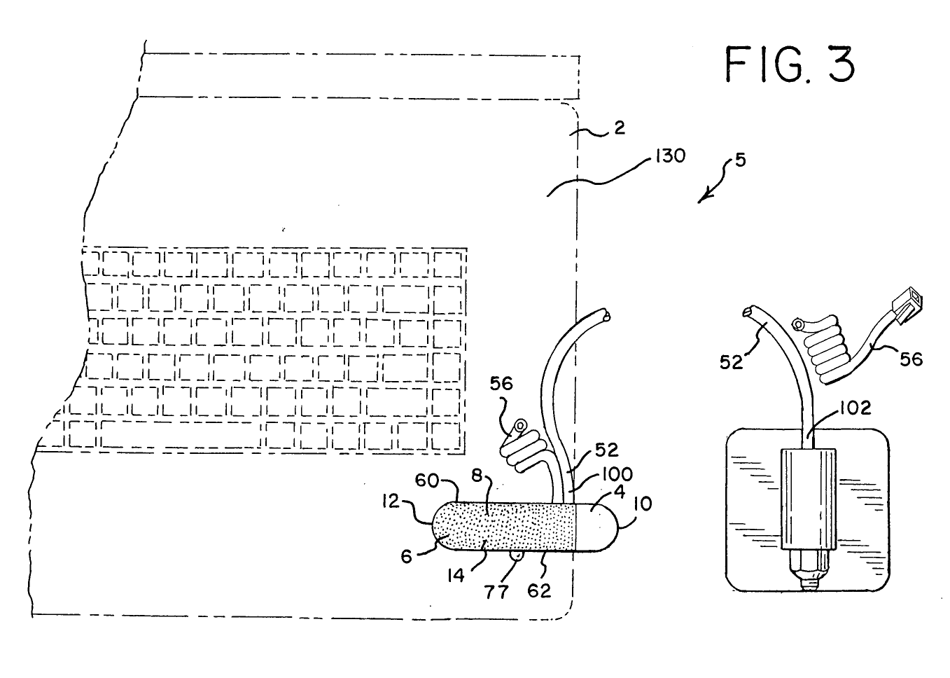

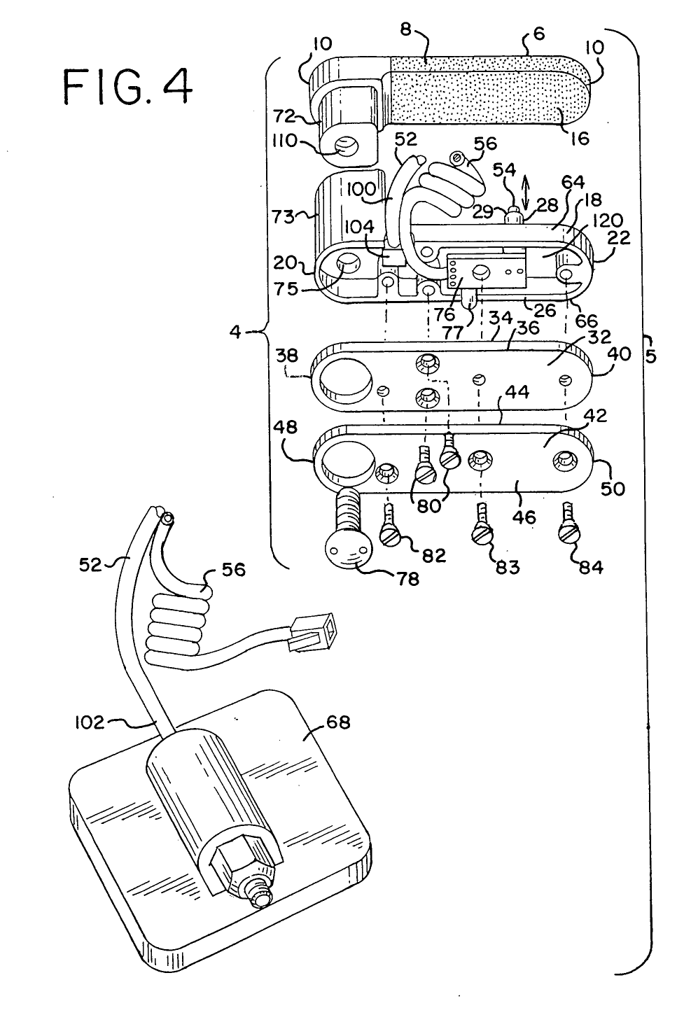

FIGS. 1-5 illustrate an embodiment of the clamp 4 and the system 5. In an embodiment, the clamp 4 may have a first arm 8 and a second arm 18. The second arm 18 may be located in a position that may be generally parallel to the first arm 8. As shown in FIGS. 1 and 2, the first arm 8 may have a length defined between a first end 10 and a second end 12. Further, the first arm 8 may have a height defined between a top surface 14 and a bottom surface 16. Preferably, the bottom surface 16 may be positioned generally parallel to the top surface 14. As shown in FIG. 3, the first arm 8 may have a width defined between a first side 60 and a second side 62. Likewise, as shown in FIGS. 1 and 2, the second arm 18 may have a length defined between a first end 20 and a second end 22. Further, the second arm 18 may have a height defined between a top surface 24 and a bottom surface 26. As shown in FIG. 4, the second arm 18 may have a width defined between a first side 64 and a second side 66. The clamp 4 may be constructed from a metal, such as, for example, steel, aluminum and/or the like.

In an embodiment, as shown in FIG. 4, the first arm 8 may have a pin 72 that may extend from the first end 10 of the first arm 8 in a direction perpendicular to the length of the first arm 8 towards the second arm 18. In an embodiment, the pin 72 may have, for example, a D-shaped cross-section. The second arm 18 may have a shaft 73 that may extend from the first end 20 of the second arm 18 in a direction perpendicular to the length of the second arm 18 towards the first arm 8. The shaft 73 may have an opening 75 that may extend through the shaft 73 and through the height of the second arm 18 to the bottom surface 26 of the second arm 18. In an embodiment, the opening 75 may have, for example, a D-shaped cross-section. The opening 75 and/or the shaft 73 may be sized to receive the pin 72 of the first arm 8. In an embodiment, the pin 72 may have a tapped hole 110 that may receive a fastener 78, such as, for example, a screw, a bolt and/or the like that may fasten the first arm 8 to the second arm 18 via the opening 75 in the shaft 73 of the second arm 18. As shown in FIGS. 1-3 and 5, the article may be situated between the first arm 8 and the second arm 18 of the clamp 4. The fastener 78 may be tightened to secure the article 2 between the first arm 8 and the second arm 18.

In an embodiment, the clamp 4 may accommodate any article 2 having a width less than a length of the pin 72 plus a length of the shaft 73. It should be understood that the pin 72, the shaft 73, the opening 75 and/or the fastener 78 may be any pin, shaft, opening and/or fastener for attaching the first arm 8 to the second arm 18 of the clamp 4 as known to one having ordinary skill in the art. Further, it should be understood that the cross-section of the pin 72 and/or the opening 75 of the shaft 73 may be any shape that may prevent a rotation of the first arm 8 with respect to the second arm 18 as known to one having ordinary skill in the art. The present invention should not be deemed as limited to a specific embodiment of the pin 72, the shaft 73, the opening 75, and/or the fastener 78.

In an embodiment, the top surface 24 of the of the second arm 18 may have a vertical member 28 that may extend from the second arm 18 in a direction perpendicular to the second arm 18 to a point between the first arm 8 and the second arm 18. In an embodiment, the vertical member 28 may be cylindrically shaped about an axis that may be perpendicular to the top surface 24 of the second arm 18. The vertical member 28 may be rigid and/or stiff and may resist shearing forces that may be exerted on the vertical member 28 in directions parallel to the top surfaces 14, 24 and/or the bottom surfaces 16, 26 of the first arm 8 and/or the second arm 18, respectively. In an embodiment, the vertical member 28 may be constructed from a metal, such as, for example, steel, aluminum and/or the like that may be suitable for resisting shearing forces. The article 2 may have a recess 1 that may be, for example, a screw hole, a notch, a crack, a crevice, a slot, a depression and/or the like. The vertical member 28 may be inserted into the recess 1 of the article 14 as the clamp 4 may be attached about the article 2. After the first arm 8 of the clamp 4 is tightened to the second arm 18 with the fastener 78, a positioning of the vertical member 28 within the recess 1 may prevent removal of the article 2 from the clamp 4. It should be understood that the vertical member 28 may be any pin, rod, shaft, or member sized for insertion into the recess 1 of the article 2 as known to one having ordinary skill in the art. Further, it should be understood that the recess 1 may be any screw hole, notch, crack, crevice, slot and/or depression, that may exist on the article 2 as known to one having ordinary skill in the art. The present invention should not be deemed as limited to a specific embodiment of the vertical member 28 and/or the recess 1.

In an embodiment, as shown in FIGS. 1 and 2, the first arm 8 and/or the second arm 18 may have a coating 6 that may be, for example, rubber, foam, plastic and/or like material. Preferably, the coating 6 may prevent cosmetic damage to the article 2 while the clamp 4 is attached about the article 2. Further, the coating 6 may increase friction between the first arm 8 and/or the second arm 18 and the article 2. The coating 6 may reduce a slippage of the article 2 from the clamp 4. It should be understood that the coating 6 may be any material that may protect the article 2 from the clamp 4 and/or that may increase friction between the article 2 and the clamp 4 as known to one having ordinary skill in the art. The present invention should not be deemed as limited to a specific embodiment of the coating 6.

In an embodiment, as shown in FIGS. 1, 2, 4 and 5, the clamp 4 may have a first plate 32 that may be attached to the bottom surface 26 of the second arm 18. The first plate 32 may have a width defined between a top side 34 and a bottom side 36 that may be located in a position opposite to the top side 34. The first plate 32 may have a length defined between a first end 38 and a second end 40. In an embodiment, the length of the first plate 32 may be substantially equal to the length of the second arm 18. The first plate 32 may be configured to create a compartment 120 between the second arm 18 and the first plate 32. In an embodiment, the first side 64 of the second arm 18 may have an opening 30 to receive a cable 52. The opening 30 may be adjacent to the first plate 32. In an embodiment, the first plate 32 may be constructed from, for example, plastic. The first plate 32 may be secured to the second arm 18 with one or more fasteners 80. In an embodiment, the fasteners 80 may be, for example, a screw, a bolt and/or the like. The present invention should not be deemed as limited to a specific embodiment of the first plate 32.

In an embodiment, as shown in FIGS. 1, 2, 4 and 5, the clamp 4 may have a second plate 42 that may be attached to the bottom side 36 of the first plate 32. The second plate 42 may have a width defined between a top side 44 and a bottom side 46 that may be located in a position opposite to the top side 44. The second plate 42 may have a length defined between a first end 48 and a second end 50. In an embodiment, the length of the second plate 42 may be substantially equal to the length of the second arm 18. In an embodiment, the second plate 42 may be constructed from a metal, such as, for example, steel, aluminum and/or the like. The second plate 42 may be secured to the bottom side 36 of the first plate 32 with one or more fasteners 82, 83, 84. In an embodiment, the fasteners 82, 83, 84 may be, for example, a screw, a bolt and/or the like. The present invention should not be deemed as limited to a specific embodiment of the second plate 42.

As shown in FIG. 3, the cable 52 may have a first end 100 and a second end 102 that may be positioned generally opposite to the first end 100. In an embodiment, the cable 52 may be constructed from a metal, such as, for example, steel, aluminum and/or like material that may be suitable for securely attaching the clamp 4 and/or the article 2 to the fixture. In an embodiment, the first end 100 of the cable 52 may have a nut 104 that may be sized to attach the first end 100 of the cable 52 to the second arm 18 of the clamp 4 that may be adjacent to the opening 30. In an embodiment, as shown in FIG. 3, the second end 102 of the cable 52 may be attached to a mounting plate 68. The mounting plate 68 may be affixed to the fixture to tether the clamp 4 and/or the article 2 to the fixture. The present invention should not be deemed as limited to a specific embodiment of the cable 52, the nut 104 and/or the mounting plate 68.

As shown in FIGS. 2 and 4, the system 5 may have a plunger 54, a plunger circuit 76, a light emitting diode (LED) 77 and/or a network cable 56 that, in conjunction with the clamp 4, may secure the article 2 to the fixture. In an embodiment, the vertical member 28 may have an opening 29 that may extend through the vertical member 28. The opening 29 may be sized to receive the plunger 54 through an entire length of the vertical member 28. In an embodiment, the plunger 54 may extend to a point between the vertical member 28 and the first arm 8 of the clamp 4. In an embodiment, the plunger 54 may be positioned in contact with the plunger circuit 76 which may be located in the compartment 120 between the second arm 18 and the first plate 32. After the article 2 is secured within the clamp 4, a surface 112 of the article 2 within the recess 1 of the article 2 may depress the plunger 54.

A depression of the plunger 54 may activate the plunger circuit 76. By detecting the depression of the plunger 54, the plunger circuit 76 may detect a presence and/or an absence of the article 2 within the clamp 4. The LED 77 may be electrically connected to the plunger circuit 76. The LED 77 may produce light that may be indicative of an activation of the plunger circuit 76 by the depression of the plunger 54. The network cable 56 may be electrically connected to the plunger circuit 76 through the opening 30 of the second arm 18. In an embodiment, the network cable 56 may be further connected to an alarm system that may be located at or near the fixture that may monitor a security of the article 2 within the clamp 4. For example, if the plunger circuit 76 is activated by the presence of the article 2 within the clamp 4, then a removal of the article 2 from the clamp 4 may result in an extension of the plunger 54. The plunger circuit 76 may detect the extension of the plunger 54 and may communicate an electrical signal through the network cable 56 to the alarm system. The alarm system may be any alarm system that may receive and/or may communicate electrical signals from and/or to the plunger circuit 76 via the network cable 56. Further, the alarm system may produce an alarm event that may indicate that the article 2 has been removed from the clamp 4. The alarm event may be, for example, an audible indicator, an electronic indicator, a visible indicator and/or the like that may alert security personnel that the article 2 may be displaced and/or removed from the clamp 4. Further, the alarm system may be used to activate the plunger circuit 76 to detect a presence and/or an absence of the article 3 within the clamp 4. The present invention should not be deemed as limited to a specific embodiment of the plunger 54, the plunger circuit 76, the LED 77, the network cable 56, the opening 29 and/or the alarm system.

In an embodiment, the system 5 may have a collar 86 that may be affixed to the article 2 to create the recess 1 in a desired location on the article 2. The collar 86 may receive the vertical member 28 of the clamp 4 in applications for which the article 2 may not have the recess 1 in an appropriate position required to attach the clamp 4 to the article 2. In an embodiment, the collar 86 may be cylindrically shaped. The collar 86 may have a height defined between a top side 90 and a bottom side 92 that may be positioned opposite to the top side 90. The collar 86 may have an adhesive layer 94 that may be adjacent to the bottom side 92 of the collar 86. The adhesive layer 94 may be, for example, a double-sided tape, an adhesive compound, an epoxy, a glue and/or the like. The adhesive layer 94 may be situated between the bottom side 92 of the collar 86 and the article 2 and may be used to attach the collar 86 to the article 2. The top side 90 of the collar 86 may have an opening 88 which may create the recess 1. The clamp 4 may be attached to the article 2 by inserting the vertical member 28 into the opening 88 of the collar 86. After the clamp 4 is attached to the article 2, the positioning of the vertical member 28 within the opening 88 of the collar 86 may prevent removal of the article 2 from the clamp 4.

In an embodiment, as shown in FIG. 5, the plunger 54 may extend through the collar 86 to contact the article 2. In an embodiment, the collar 86 may be constructed from, for example, plastic. It should be understood that the collar 86 and the adhesive layer 94 may be any fitting for receiving the vertical member 28 and/or any adhesive layer, respectively, as known to one having ordinary skill in the art. The present invention should not be deemed as limited to a specific embodiment of the collar 86 and/or the adhesive layer 94.

In an embodiment, as shown in FIGS. 1, 2 and 5, the article 2 may have a width defined between a first surface 130 and a second surface 132. The second surface 132 may be positioned generally opposite and/or parallel to the first surface 130. Moreover, the second surface 132 may have the recess 1 and/or the collar 86 thereon. To secure the article 2 to the fixture, a user of the clamp 4 and/or the system 5 may place the first arm 8 of the clamp 4 adjacent to the first surface 130 of the article 2. Further, the user may place the second arm 18 of the clamp 4 adjacent to the second surface 132 of the article 2. The bottom surface 16 of the first arm 8 may be adjacent to first surface 130 of the article 2. The top surface 24 of the second arm 18 may be adjacent to the bottom surface 132 of the article 2. Further, the vertical member 28 may be positioned within the recess 1 of the article 2 or the collar 86. Moreover, the pin 72 may be situated within the opening 75 of the shaft 73 at a position adjacent to the width of the article 2. After the first arm 8, the second arm 18, the vertical member 28, the pin 72 and/or the shaft 73 are situated about the article 2, the user may fasten the first arm 8 to the second arm 18 using the fastener 78 and the tapped hole 110. The fastener 78 may be rotated by the user until the first arm 8 and the second arm 18 are drawn together a distance that may prevent removal of the clamp 4 from the article 2.

A positioning of the first arm 8 with respect to the second arm 18 may prevent and/or may resist a movement of the clamp 4 in directions perpendicular with respect to the first surface 130 and/or the second surface 132 of the article 2. Further, the coating 6 may increase friction between the first arm 8 and/or the second arm 18 and the first surface 130 and/or the second surface 132 of the article 2, respectively. Therefore, the coating 6 may impede a movement of the clamp 4 in directions parallel with respect to the first surface 130 and/or the second surface 132 of the article 2. Moreover, the vertical member 28 within the recess 1 may prevent and/or resist a movement of the clamp 3 in directions parallel with the first surface 130 and/or the second surface 132 of the article 2. The prevention and/or the resistance of movement of the clamp in both the directions perpendicular and parallel with respect to the first surface 130 and/or the second surface 132 may effectively prevent removal of the clamp 4 from the article 2. Therefore, absent removal of the fastener 78 from the tapped hole 110 and/or absent the destruction and/or damage of the first arm 8, the second arm 18 and/or the article 2, the clamp 4 may not be removed from the article 2. As a result, the attachment of the cable 52 to both the clamp 4 and the fixture with the mounting plate 68 may prevent the removal of the article 2 from the fixture.

However, in some instances, tampering with the clamp 4, the cable 52 and/or the article 2 may result in the removal of the article from the fixture without alerting the security personnel. Therefore, for increased security of the article 2 to the fixture, the plunger 54, the plunger circuit 76 and the network cable 56 (in conjunction with the security system) may be used to alert the security personnel of the removal of the article 2 from the clamp 4 and/or from the fixture. For example, if the article 2 is removed from the clamp 4, the plunger 54 may be extended by the plunger circuit 76 which may communicate the electrical signal through the network cable 56 to the alarm system. As a result, the alarm system may produce the alarm event that may indicate that the article 2 has been removed from the clamp 4. However, if the cable 52 and/or the mounting plate 68 is compromised and the article 2 and the clamp 4 situated thereon are removed from the fixture, the network cable 56 may be removed from the plunger circuit 76 and/or the alarm system and/or may be severed between the clamp 4 and the alarm system. As a result, the alarm system may produce the alarm event that may indicate that the article 2 has been removed from the fixture. Therefore, the clamp 4, the system 5 and/or the method detailed herein may mechanically and/or electronically secure the article 2 to the fixture.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A clamp for securing an article to a fixture, the clamp comprising:
a first arm having a length defined between a first end and a second end wherein the second end of the first arm is positioned opposite to the first end of the first arm wherein the first arm has a height defined between a top surface and a bottom surface wherein the bottom surface of the first arm is positioned generally parallel to the top surface of the first arm;
a second arm positioned generally parallel to the first arm;
a pin extending from the first end of the first arm towards the second arm in a direction perpendicular to the bottom surface of the first arm;
a shaft extending from the second arm towards the first arm in a direction perpendicular to the second arm wherein the shaft has an opening sized to receive the pin of the first arm; and
a member extending from the second arm in a direction perpendicular to the second arm to a point between the bottom surface of the first arm and the second arm wherein the member is generally cylindrical about an axis extending perpendicular to the second arm.

2. The clamp of claim 1 further comprising:
a threaded hole in the pin.

3. The clamp of claim 1 further comprising:
a fastener to connect the pin to the shaft.

4. The clamp of claim 1 further comprising:
an opening in the member between the second arm and the point.

5. The clamp of claim 1 further comprising:
a plunger extending from the member towards the bottom surface of the first arm wherein the plunger moves within the member.

6. The clamp of claim 1 further comprising:
an opening in the second arm that extends through the second arm.

7. The clamp of claim 1 further comprising:
a first plate attached to the second arm wherein the first plate has a width defined between a first side and a second side wherein the first side of the first plate is attached to the second arm to form a compartment between the second arm and the first plate.

8. The clamp of claim 7 further comprising:
a second plate attached to the second side of the first plate wherein the second plate the first plate to the second arm.

9. The clamp of claim 1 further comprising:
a coating on the first arm wherein the coating increases a friction force of the first arm.

10. The clamp of claim 1 further comprising:
a cable attached to the second arm and to the fixture.

11. A system for securing an article to a fixture, the system comprising:
a clamp having a first arm and a second arm wherein the first arm is positioned generally parallel to the second arm wherein the first arm is attached to the second arm;
a member extending from the second arm towards the first arm in a direction perpendicular to the second arm to a point between the first arm and the second arm wherein the member is generally cylindrical about an axis that extends perpendicular to the second arm;
a plunger that extends from the first member towards the first arm wherein the plunger moves within the member in a direction perpendicular to the first arm and the second arm;
a plunger circuit in communication with the plunger wherein the plunger circuit is located within the second arm wherein the plunger circuit detects a movement of the plunger;
a first cable having a first end and second end wherein the first end is connected to the second arm; and
a second cable connected to the plunger circuit.

12. The system of claim 11 further comprising:
a mounting plate attached to the fixture wherein the second end of the first cable is attached to the mounting plate.

13. The system of claim 11 further comprising:
a collar attached to the article wherein the collar is generally cylindrical in shape wherein the collar has an opening sized to receive the member.

14. The system of claim 11 further comprising:
a fastener to attach the first arm of the clamp to the second arm of the clamp.

15. The system of claim 11 further comprising:
a light emitting diode electrically connected to the plunger circuit.

16. The system of claim 11 further comprising:
a coating on the first arm of the clamp wherein the coating protects the article from the first arm.

17. A method for securing an article to a fixture wherein the article has a recess on a surface of the article, the method comprising the steps of:
providing a clamp having a first arm and a second arm wherein the second arm is positioned generally parallel to the first arm at a substantially continuous distance from the first arm wherein the clamp has a member that extends from the second arm towards the first arm wherein the clamp has a cable wherein the cable is attached to the second arm of the clamp and further wherein the clamp has a plunger circuit to detect an attachment of the clamp to the article;
positioning the article between the first arm and the second arm;
inserting the member of the clamp into the recess of the article; and
fastening the first arm to the second arm.

18. The method of claim 17 further comprising the step of:
activating the plunger circuit to detect a removal of the article from the clamp.

19. The method of claim 17 further comprising the step of:
adjusting the distance between the first arm and the second arm.

20. The method of claim 17 further comprising the step of:
attaching the cable to the fixture.
